(19) United States
(12) Patent Application Publication
(10) Pub. No.: US 2013/0045634 A1
(43) Pub. Date: Feb. 21, 2013

(54) CONNECTOR

(71) Applicants: Tetsugaku TANAKA, Shinagawa (JP); Tohru Yamakami, Shinagawa (JP); Takeshi Okuyama, Shinagawa (JP); Toshihiro Kusagaya, Shinagawa (JP)

(72) Inventors: Tetsugaku TANAKA, Shinagawa (JP); Tohru Yamakami, Shinagawa (JP); Takeshi Okuyama, Shinagawa (JP); Toshihiro Kusagaya, Shinagawa (JP)

(73) Assignee: FUJITSU COMPONENT LIMITED, Tokyo (JP)

(21) Appl. No.: 13/587,483

(22) Filed: Aug. 16, 2012

(30) Foreign Application Priority Data
Aug. 19, 2011 (JP) 2011-179528

(51) Int. Cl. H01R 24/28

(52) U.S. Cl. 439/626

(57) ABSTRACT

A connector includes: a housing; and a connector module; the connector module including: a projection portion that projects outside from the housing; a substrate composed of a material with thermal conductivity; and a terminal that is fixed to a lower part of the substrate and contacts on an external substrate.

### CROSS-REFERENCE TO RELATED APPLICATION

This application is based upon and claims the benefit of priority of the prior Japanese Patent Application No. 2011-179528, filed on Aug. 19, 2011, the entire contents of which are incorporated herein by reference.

### FIELD

A certain aspect of the embodiments discussed herein is related to a connector.

### BACKGROUND

Conventionally, there has been known a connector that are welded to a contact pad on a printed circuit board by melting a solder by a reflow process (Japanese Laid-Open Patent Publication No. 2011-060427 and Japanese National Publication of International Patent Application No. 2007-502527). The reflow process is a process in which parts are mounted on the printed circuit board on which the solder has been printed, the printed circuit board is heated by the hot air of a heating device to melt the solder, and the parts and the printed circuit board are combined.

### SUMMARY

According to an aspect of the present invention, there is provided a connector, including: a housing; and a connector module; the connector module including: a projection portion that projects outside from the housing; a substrate composed of a material with thermal conductivity; and a terminal that is fixed to a lower part of the substrate and contacts on an external substrate.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating the schematic configuration of a connector 10 and a substrate 50 according to a present embodiment;

FIG. 2A is a perspective view illustrating the configuration of a back surface of the connector 10;

FIG. 2B is a perspective view illustrating the configuration of the back surface of the connector 10 when a plurality of connector modules 12 are incorporated into the connector 10;

FIG. 3 is a diagram illustrating the configuration of the connector module 12 included in the connector 10;

FIG. 4 is a diagram illustrating a set of connector modules 12;

FIG. 5A is a cross-section diagram of the connector module 12 and the substrate 50 on a line passing a signal terminal 23;

FIG. 5B is a cross-section diagram of the connector module 12 and the substrate 50 on a line passing a ground terminal 24;

FIG. 6 is a diagram illustrating a state where heat is conducted to the signal terminal 23 and the ground terminal 24 from a projection unit 26;

FIG. 7A is a perspective view illustrating the back surface of the connector 10;

FIG. 7B is a diagram illustrating a first variation example of the projection unit 26 of the connector module 12;

FIG. 8A is a perspective view illustrating the back surface of the connector 10;

FIG. 8B is a diagram illustrating a second variation example of the projection unit 26 of the connector module 12;

FIG. 9 is a diagram illustrating a variation example of the connector module 12; and

FIGS. 10A and 10B are diagrams illustrating variation examples of a housing 11 of the connector 10.

### DESCRIPTION OF EMBODIMENTS

A description will now be given of an exemplary embodiment with reference to the accompanying drawings.

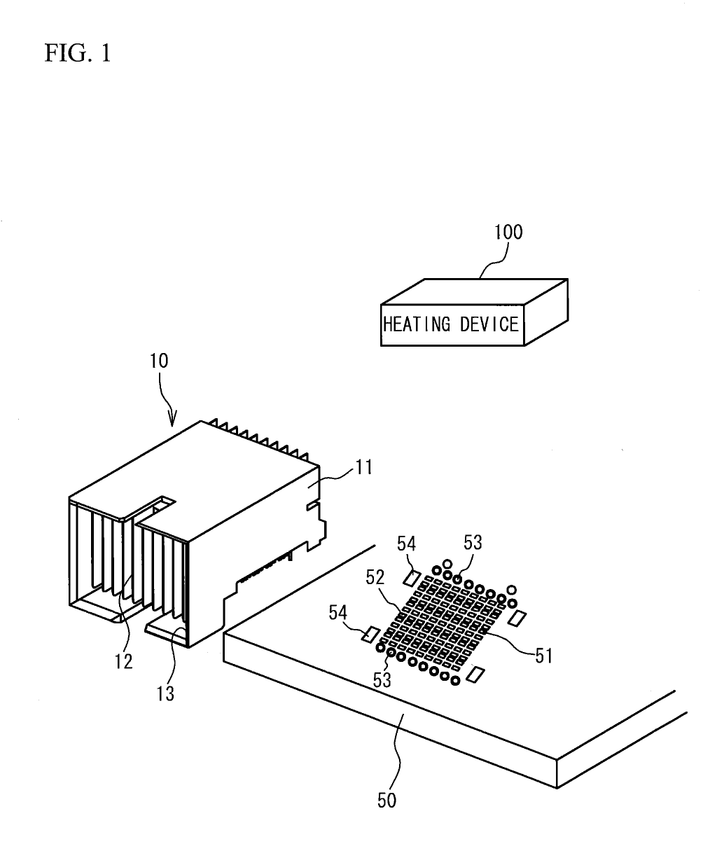

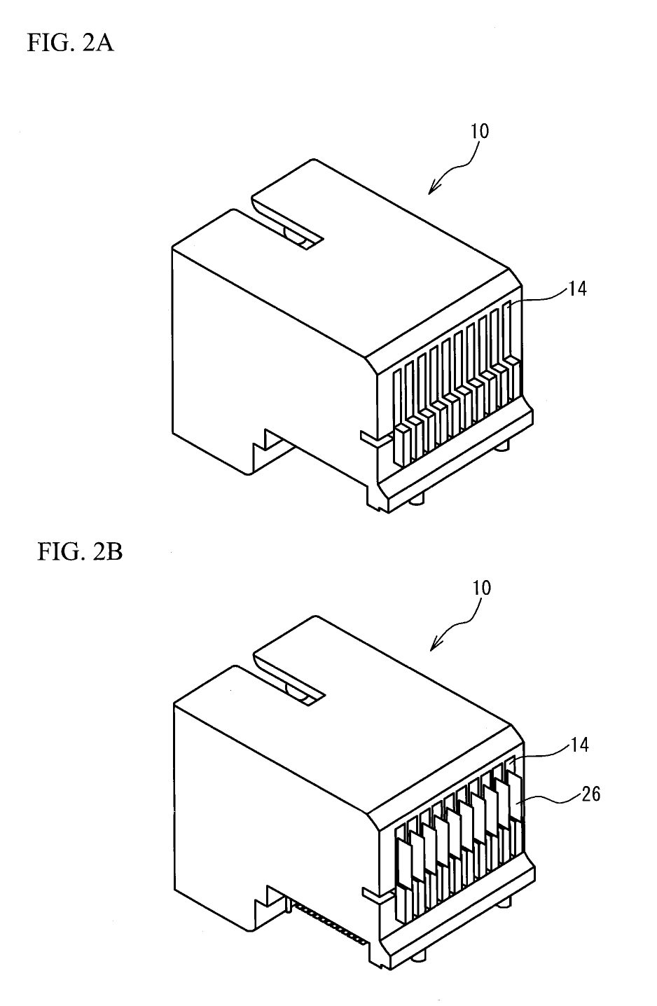

FIG. 1 is a diagram illustrating the schematic configuration of a connector 10 and a substrate 50 according to a present embodiment. FIG. 2A is a perspective view illustrating the configuration of a back surface of the connector 10. FIG. 2B is a perspective view illustrating the configuration of the back surface of the connector 10 when a plurality of connector modules 12 are incorporated into the connector 10.

In FIG. 1, the connector 10 is mounted on a surface of the substrate 50, and is a high-density connector used for a computer, a personal computer, a work station, and so on. The connector 10 includes a housing 11 made of an insulator, and a plurality of connector modules 12 incorporated into the housing 11. Here, although the plurality of connector modules 12 are incorporated into the housing 11, it suffices that the connector 10 includes at least one connector module.

An opening 13 is formed on a front surface of the connector 10, and another connector, not shown, is attached to the connector modules 12 via the opening 13. Each of slits 14 for exposing outside a part of each connector module 12 (i.e., a projection unit 26 described later) is formed on the back surface of the connector 10, as illustrated in FIG. 2A. FIG. 2B illustrates a state where the part of each connector module 12 is exposed outside.

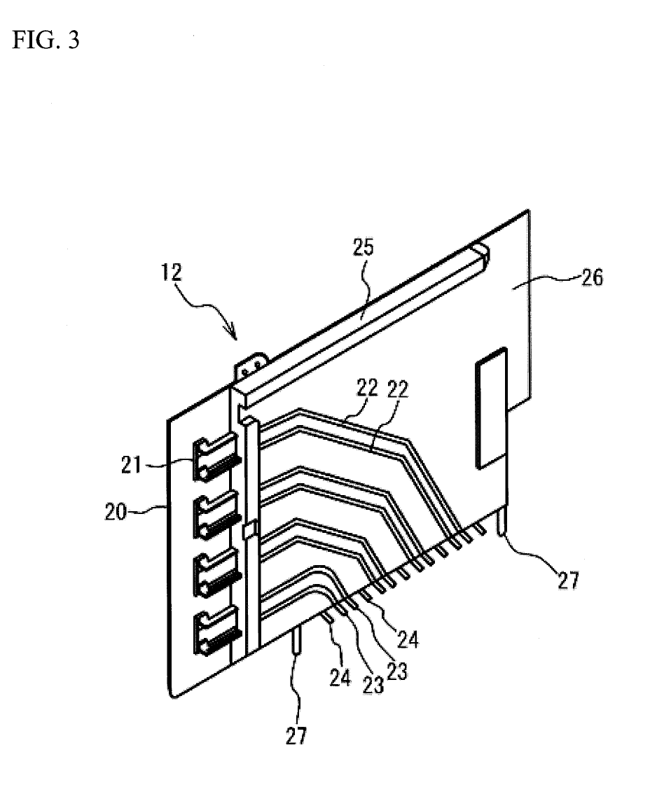

In FIG. 1, the substrate 50 as an external substrate is a rigid substrate such as a glass epoxy substrate. The substrate 50 includes: electrode pads 51; solder 52 applied on the electrode pads 51; holes 53 for fixing leg units 27 (see FIG. 3) extended in a vertical direction from the connector module 12; and concave units 54 for fixing the housing 11. By a reflow process, the hot air of a heating device 100 heats the substrate 50 to melt the solder 52, and hence the connector 10 is fixed on the substrate 50. In the reflow process, the heating device 100 sends the hot air to the connector 10 and the substrate 50 from an upper side of the connector 10 and the substrate 50.

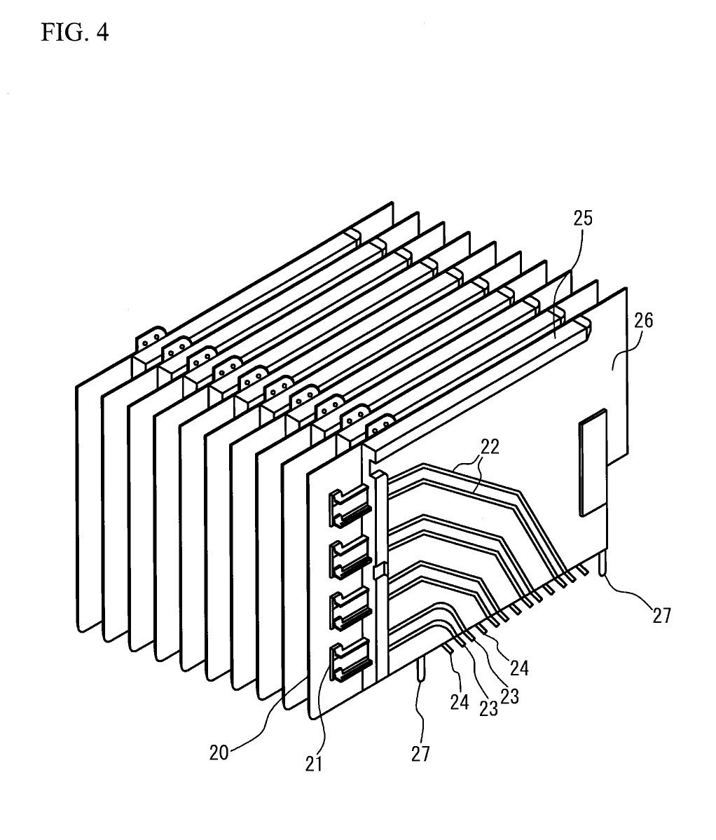

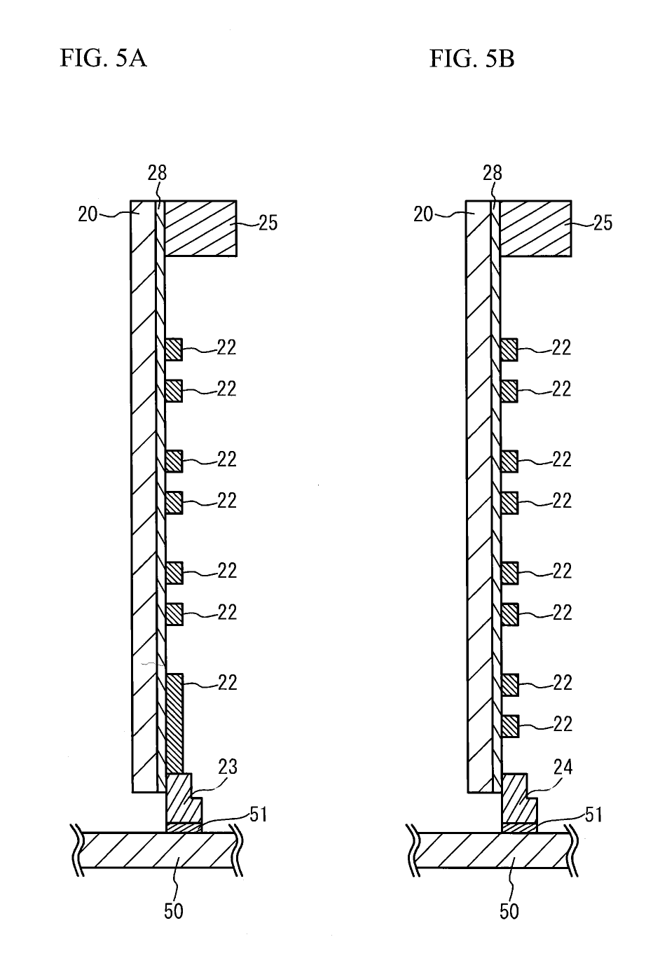

FIG. 3 is a diagram illustrating the configuration of the connector module 12 included in the connector 10. FIG. 4 is a diagram illustrating a set of connector modules 12. FIG. 5A is a cross-section diagram of the connector module 12 and the substrate 50 on a line passing a signal terminal 23. FIG. 5B is a cross-section diagram of the connector module 12 and the substrate 50 on a line passing a ground terminal 24.

The connector module 12 includes a substrate 20, sockets 21, signal lines 22, and a frame 25, as illustrated in FIG. 3. The frame 25 is composed of resin made from a plastic, for example. The frame 25 is provided on an upper part of the substrate 20, and defines a distance between the connector modules 12, as illustrated in FIG. 4. That is, the connector module 12 is separated from an adjacent connector module 12 by the thickness of the frame 25.

The substrate 20 is composed of a metal with high thermal conductivity, such as aluminum or copper, and an insulated film 28 is applied to the surface of the metal (see FIGS. 5A and 5B). The substrate 20 includes the projection unit 26 to be exposed outside from the back surface of the connector 10, as illustrated in FIG. 3.

The sockets 21 are connected to another connector to be connected to the connector 10. The connector module 12 includes four sockets 21, but the number of sockets 21 is not limited to this. Each socket 21 is connected to two signal terminals 23 via two signal lines 22. The two signal terminals 23 are fixed to a lower part of the substrate 20, and extends in a horizontal direction from the lower part of the substrate 20. A plurality of ground terminals 24 extend in the horizontal direction from the lower part of the substrate 20. The two signal terminals 23 are provided between a ground terminal 24 and an adjacent ground terminal 24. The signal terminals 23 and the ground terminals 24 are disposed on the electrode pads 51, and fixed on the electrode pads 51 by melting the solder 52.

In addition, the leg units 27 extend vertically downwards from the lower part of the substrate 20, and are inserted into the holes 53 on the substrate 50. Thereby, the motion in the horizontal direction of the connector module 12 is inhibited. Protrusions, not shown, fit in the concave units 54 are formed on a bottom surface of the housing 11.

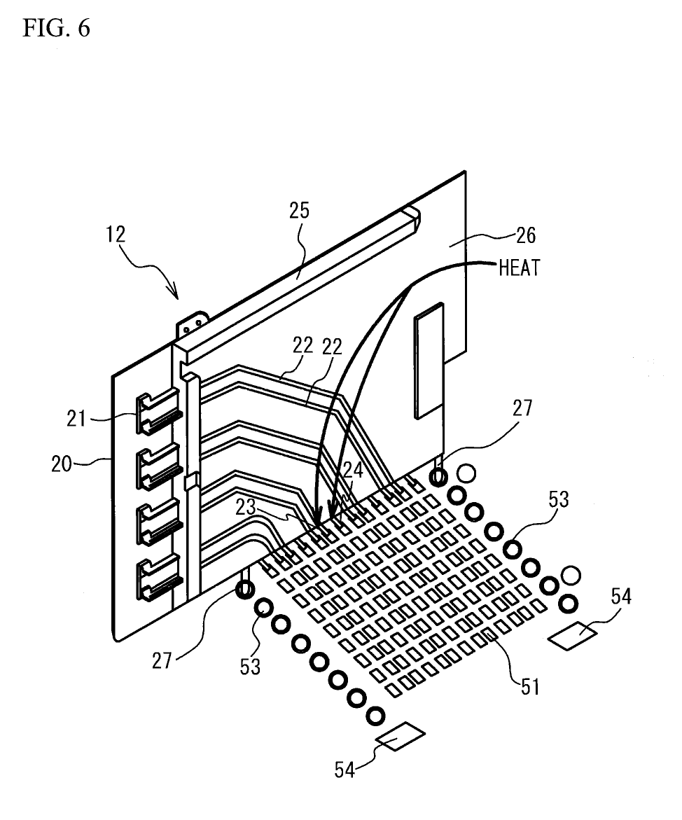

The connector 10 constituted as mentioned above absorbs the heat of the heating device 100 from the projection unit 26 of the connector module 12, as illustrated in FIG. 6. The heat by the heating device 100 is conducted to the signal terminals 23 and the ground terminals 24 via the substrate 20. Thereby, the solder 52 on the electrode pads 51 in contact with the signal terminals 23 and the ground terminals 24 is melted easily.

When the connector 10 is used, the heat generated by the substrate 50 is conducted to the projection unit 26 of the connector module 12 via the signal terminals 23 and the ground terminals 24. Therefore, the projection unit 26 of the connector module 12 has a function as a heat sink emitting the heat generated by the substrate 50.

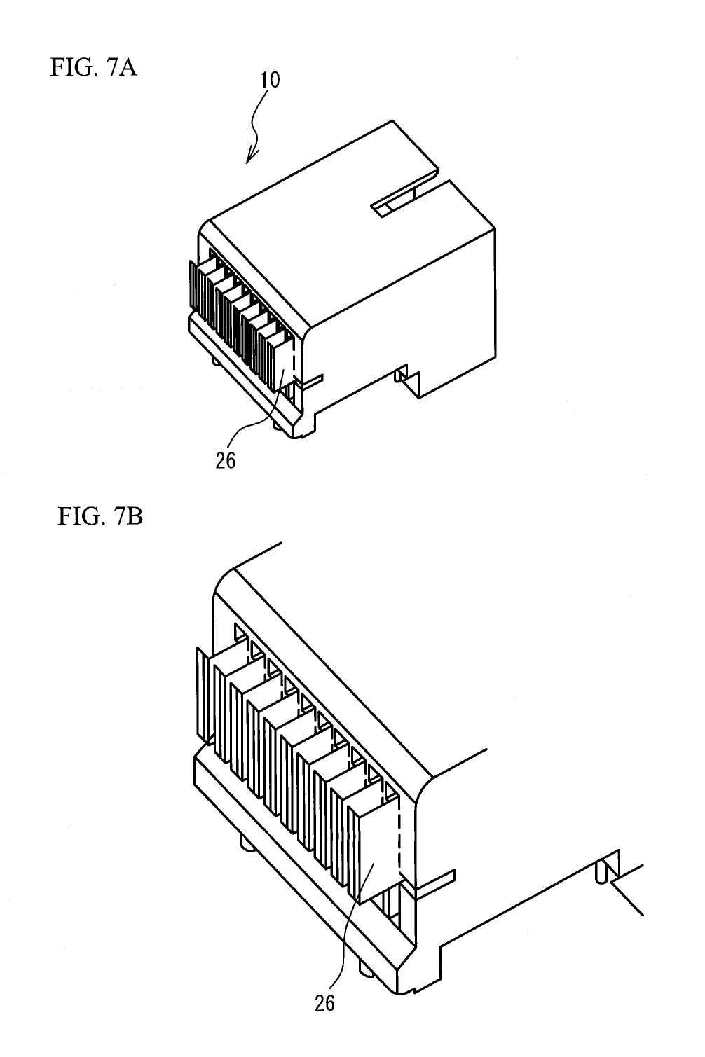

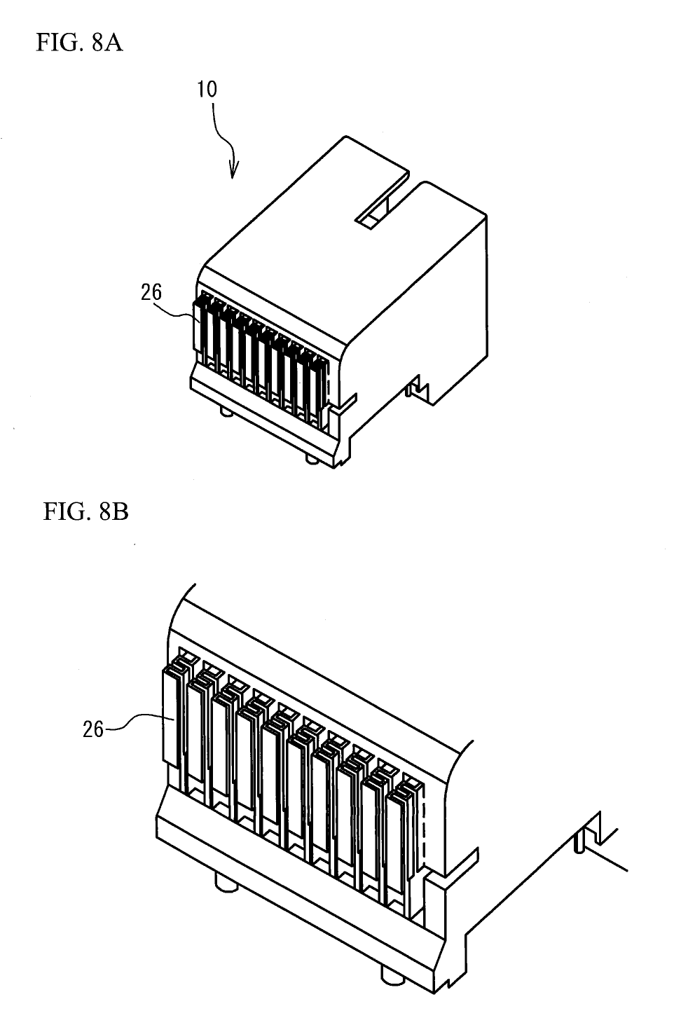

FIG. 7A is a perspective view illustrating the back surface of the connector 10. FIG. 7B is a diagram illustrating a first variation example of the projection unit 26 of the connector module 12. FIG. 8A is a perspective view illustrating the back surface of the connector 10. FIG. 8B is a diagram illustrating a second variation example of the projection unit 26 of the connector module 12.

In FIG. 3, the projection unit 26 of the connector module 12 is a flat plate. However, as illustrated in FIG. 7B, the projection unit 26 of the connector module 12 may be bent in a direction of a side surface of the housing 11 of the connector 10 (i.e., bent in parallel with a side surface of the housing 11), for example. That is, the projection unit 26 of the connector module 12 may be bent in the shape of an “L” character, as viewed from above. Thereby, a direction and an area of a surface which easily receives the hot air can be increased. In addition, the projection unit 26 of the connector module 12 may be bent like a meandering shape, as illustrated in FIG. 8B. That is, the projection unit 26 of the connector module 12 may be bent two or more times in the direction of the side surface of the housing 11. Thereby, the surface area which absorbs the heat can be increased.

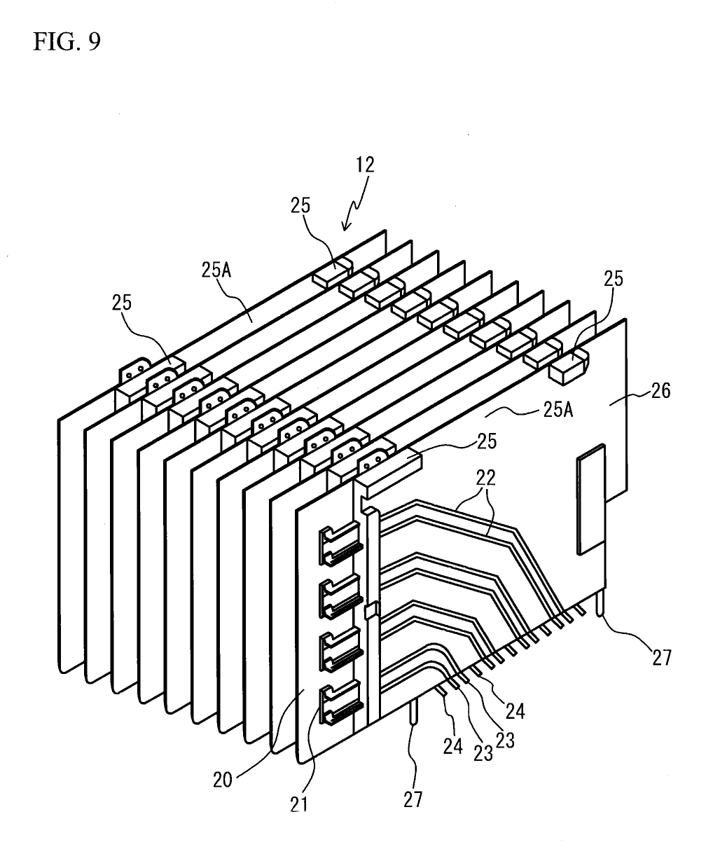

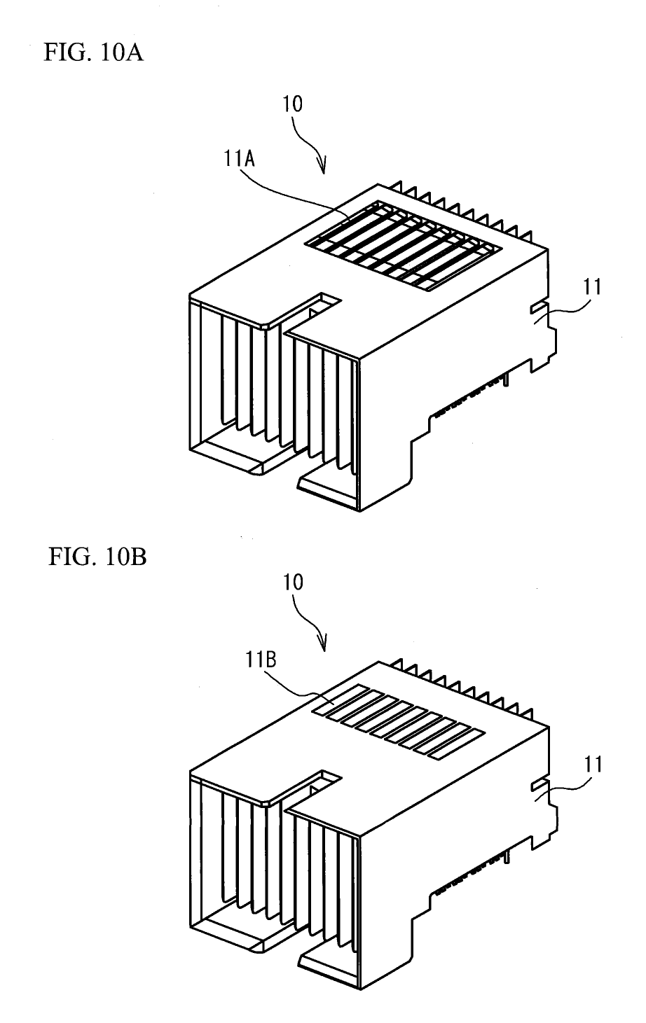

FIG. 9 is a diagram illustrating a variation example of the connector module 12. FIGS. 10A and 10B are diagrams illustrating variation examples of the housing 11 of the connector 10.

An opening unit 25A (a first opening portion) is formed at a position on the frame 25 opposed to the signal terminals 23 and the ground terminals 24, as illustrated in FIG. 9. An opening unit 11A is formed on a top surface of the housing 11, as illustrated in FIG. 10A. Alternatively, slits 11B may be formed on the top surface of the housing 11, as illustrated in FIG. 10B. Each of the opening unit 11A and the slits 11B functions as a second opening portion, and is formed on a position opposed to the opening unit 25A.

By forming the opening unit 25A and any one of the opening unit 11A and the slits 11B, a user can check the states of each signal terminal 23 and each ground terminal 24. That is, the user can check whether each signal terminal 23 and each ground terminal 24 are fixed on the electrode pads 51 by melting the solder 52. In addition, the hot air of the heating device 100 reaches the solder 52 easily by forming the opening unit 25A and any one of the opening unit 11A and the slits 11B.

As described above, according to the present embodiment, the heat absorbed in the projection unit 26 is conducted to the substrate 50 via the substrate 20, the signal terminals 23 and the ground terminals 24, and hence it is possible to easily melt the solder 52 on the substrate 50.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various change, substitutions, and alterations could be made hereto without departing from the spirit and scope of the invention.

What is claimed is:

1. A connector, comprising:
a housing; and
a connector module;
the connector module including:
a projection portion that projects outside from the housing;
a substrate composed of a material with thermal conductivity; and
a terminal that is fixed to a lower part of the substrate and contacts on an external substrate.

2. The connector according to claim 1, wherein the projection portion is bent in a direction of a side surface of the housing.

3. The connector according to claim 1, wherein the projection portion is bent like a meandering shape.

4. The connector according to claim 1, further comprising:
a plurality of connector modules; and
a frame that is provided on an upper part of the substrate, and defines a distance between the connector modules;
wherein a first opening portion is formed at a position on the frame opposed to the terminal, and a second opening portion is formed at a position on the housing opposed to the first opening portion.
